(19) United States
(12) Patent Application Publication
(10) Pub. No.: US 2007/0296155 A1
(43) Pub. Date: Dec. 27, 2007

(54) Seal Arrangement, Bicycle Pedal Crank Bearing and Bicycle Hub with Seal Arrangement

(75) Inventors: Jesko-Henning Tanke, Schweinfurt (DE); Bernd Stephan, Schweinfurt (DE)

Correspondence Address: BUCHANAN, INGERSOLL & ROONEY PC, POST OFFICE BOX 1404, ALEXANDRIA, VA, 22313-1404, US

(73) Assignee: AB SKF, Goteborg (SE)

(21) Appl. No.: 11/662,962

(22) PCT Filed: Aug. 5, 2005
(86) PCT No.: PCT/EP05/08518

§ 371 Date: May 17, 2007

(30) Foreign Application Priority Data
Sep. 15, 2004 (DE) 10 2004 045 014.5

(51) Int. Cl. B62K 19/34; F16C 19/26; F16J 15/50; G05G 1/14

(52) U.S. Cl. 277/345; 384/545; 74/594.1

(57) ABSTRACT

The sealing arrangement of a bicycle comprises the following features: a first element which extends in the axial direction; a second element which extends in the axial direction and at least partly encloses the first element; the elements are mounted in such a way that they can rotate in relation to each other; a space to be sealed, which extends between the two elements, is in the region of at least one axial end section of one of the elements closed with a sealing ring that is arranged between the two elements; the sealing ring is attached to the second element and comprises a sealing lip which makes sealingly contact with a surface extending radially and completely encircling the first element; and bottom bracket ball bearing and/or bicycle hub with the sealing arrangement.

The invention relates to the seal arrangement of a bicycle and a bicycle pedal crank bearing and a bicycle hub with the seal arrangement.

DE 90 14 394 U1 discloses a seal for a pedal axle bearing arrangement of a bicycle in which a sealing disk which adjoins the shaft to form a seal is located between the sealing sleeve and the sealing element, the sealing sleeve being provided with a section which runs in the axial direction and which is located projecting into the space between the shaft and the sleeve which surrounds a shaft. In this connection, good protection against dirt and water with little friction will be achieved with this configuration.

The object of the invention is to devise an improved seal arrangement of a bicycle which has especially a sufficient sealing action when dirt and/or moisture particles penetrate with a comparative high pressure in the direction of the seal arrangement.

The object is achieved by the subject matter of claim 1. Advantageous embodiments are described in the dependent claims.

As claimed in claim 1 the seal arrangement of a bicycle has the following features:
A first element which extends in the axial direction,
a second element which extends in the axial direction and which surrounds the first at least in a partial region,
the elements are pivotally supported against one another,
a space which is to be sealed and which extends between the elements is closed in the region of at least one axial end section of one of the elements with a gasket which is located essentially between the elements and
the gasket is attached to the second element and has a sealing lip which adjoins the surface of the first element, forming a seal, which surface runs peripherally in the manner of a ring and extends in the radial direction.

Especially because the sealing lip adjoins the surface of the first element, forming a seal, which surface runs peripherally in the manner of a ring and extends in the radial direction, the sealing lip is pressed more strongly as desired especially with the penetration of moisture and/or dirt particles under elevated pressure in the direction of the gasket, especially when the bicycle is being cleaned with a pressure washer, and thus intensification of its sealing action is achieved, conversely in normal riding of the bicycle the sealing lip is adjoining with a pressure which is smaller but nevertheless ensures a good sealing action for normal riding, and which causes low friction and thus little wear of the sealing lip and thus a long service life of the gasket.

Furthermore, for the sealing arrangement as claimed in claim 1, a design is advantageously promoted which allows automatic re-emergence of moisture and/or dirt particles which have penetrated in spite of the gasket due to the force of gravity.

In one advantageous configuration the seal arrangement comprises a ring-like element which is connected to the first element, which is upstream of the gasket, and which with its outside jacket surface in the radial direction to the opposite inner jacket surface of the second element is made and arranged to form a narrow, hollow-cylindrical gap. In this way an upstream sealing function for the gasket is formed, so that direct and unbraked penetration of dirt and/or moisture particles especially toward the sealing lip is prevented, for example when cleaning the bicycle with a pressure washer.

In another advantageous configuration the gasket is provided with an annular spring. In this way especially for a sealing lip with a V-shaped lengthwise sectional profile an intensified sealing action can be achieved by the tip of the V-shape as another sealing lip adjoining the essentially axially extended surface, forming a seal; this is advantageous especially for bicycles which are designed for use on difficult terrain.

Other advantages, features and details of the invention will become apparent from the embodiments of the invention described below using the Figures.

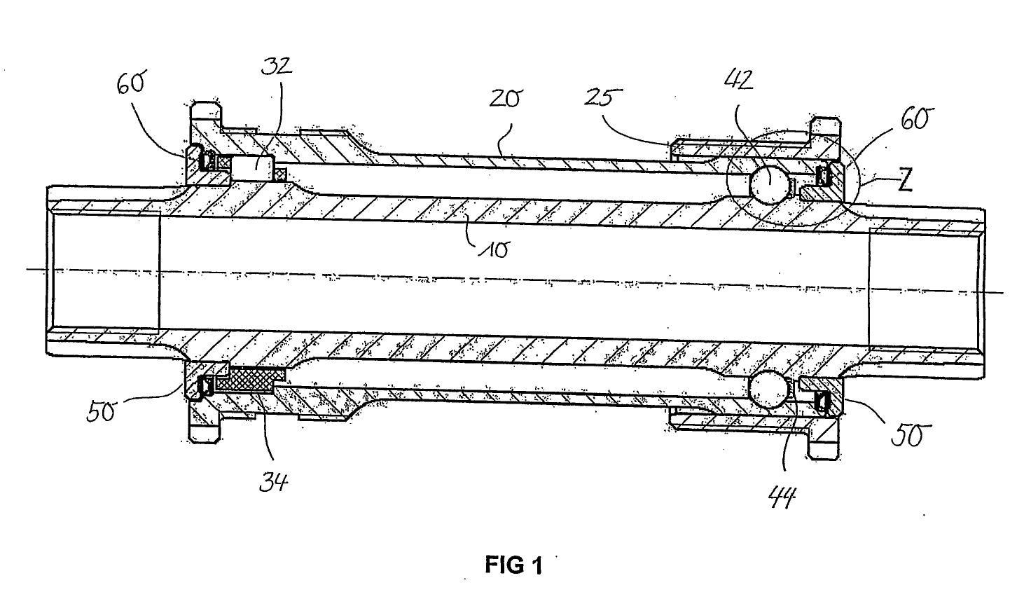

FIG. 1 shows a lengthwise section through a bicycle pedal crank bearing with a seal arrangement,

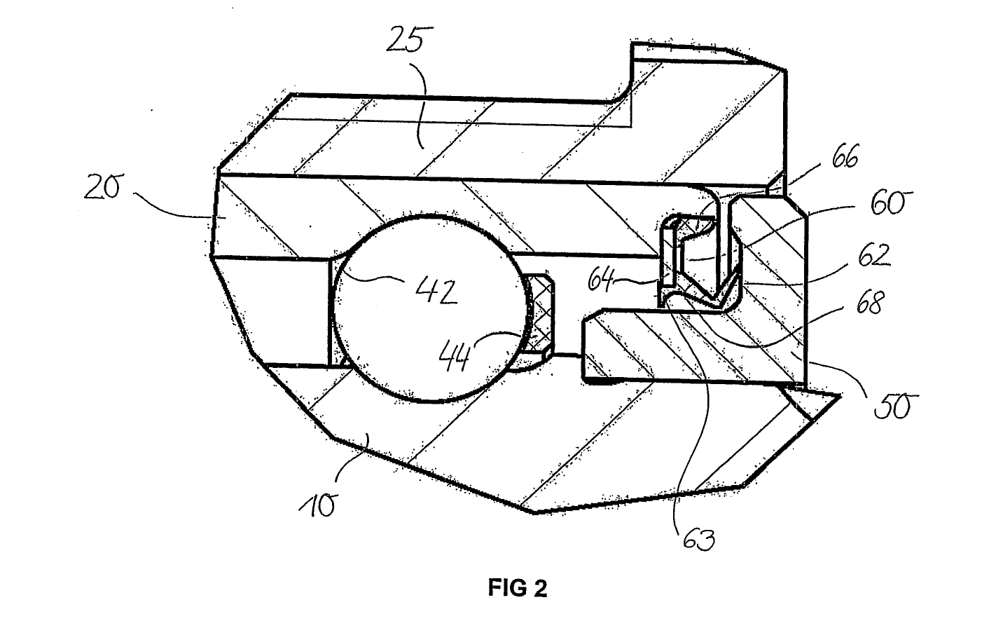

FIG. 2 shows an enlarged extract of FIG. 1 in the region of the seal arrangement and

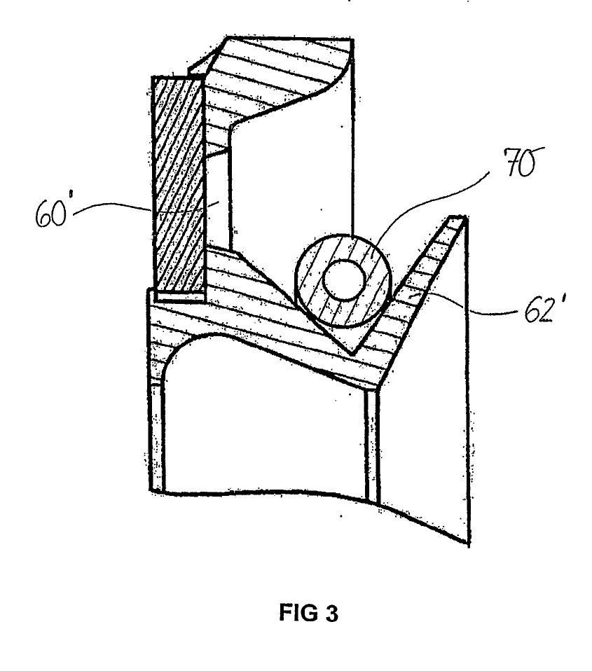

FIG. 3 shows a lengthwise section through the top half of a gasket which is provided with an annular spring.

FIG. 1 shows as one embodiment of the invention a lengthwise section through the pedal crank bearing of a bicycle. In this connection the pedal crank bearing of the bicycle comprises a shaft 10 which is made essentially as a hollow cylinder and an outer sleeve 20 which is arranged to surround the shaft 10 such that the two axial end regions of the shaft 10 project beyond the axial extension of the outer sleeve 20.

The shaft 10 is pivotally supported in the outer sleeve 20 via two antifriction bearings. One of the antifriction bearings is made as a cylindrical roller bearing, the cylinder rollers 32 being guided in a cage 34 and the shaft 10 forming an inner track and the outer sleeve 20 forming an outer track of the cylindrical roller bearing. The other of the antifriction bearings is made as a ball bearing, the balls 42 likewise being guided in a cage 44 and in the same manner as for the cylindrical roller bearing the shaft 10 forming an inner track and the outer sleeve 20 forming an outer track for the balls 42.

Between the outer sleeve 20 and the shaft 10 a space extends which is to be sealed and which contains the two antifriction bearings; to seal it on each of the two axial ends of the outer sleeve 20 there is one auxiliary ring 50 at a time in conjunction with the gasket 60. FIG. 2 shows an enlarged extract from the region labelled Z in FIG. 1, in the following the structure and manner of operation of the auxiliary ring 50 and of the gasket 60 being described by way of example for the ball bearing side shown in FIG. 2; but this applies in the corresponding manner also to the cylindrical roller bearing side.

As is especially apparent in FIG. 2, the gasket 60 is made with an essentially C-shaped lengthwise sectional profile, the radially inner end of the C-shape being continued to form a sealing lip 62 which has essentially a V-shaped lengthwise sectional profile. In this connection, the gasket 60 is installed from the outside with the back of the C-shape forward and is pressed into a correspondingly shaped axial end region of the outer sleeve 20 into the outer sleeve 20.

The auxiliary ring 50 has roughly a L-shaped lengthwise sectional profile and is pressed onto the shaft 10 from the outside with one leg of the L-shape forward, so that the corner point of the L-shape adjoins the shaft 10 axially outside. The auxiliary ring 50 is for example produced from aluminum.

The entire pedal crank bearing arrangement is made such that with proper assembly the sealing lip 62 only on the free end of its V-shape touches the essentially radially extending end surface of the auxiliary ring 50, forming a seal. Furthermore the tip of the V-shape of the sealing lip 62 is located spaced with a short distance to the essentially axially extending jacket surface of the auxiliary ring 50.

The auxiliary rings 50 are made such that they form a narrow hollow cylinder-like gap to the outer sleeve 20 and to the intermediate sleeve 25 attached to the outer sleeve 20, so that the auxiliary rings 50 act as a type of labyrinth-like upstream seals for the gaskets 60. In particular, when the arrangement is being cleaned, for example with a pressure washer from the outside, as a result of the upstream sealing function of the auxiliary rings 50, direct and unbraked penetration of dirt and/or moisture particles in the direction of the gaskets 60 is prevented. Furthermore, the water and/or dirt particles penetrating to the gaskets 60 based on the design of the gaskets 60 nevertheless cause an intensified sealing action advantageously by intensified pressing of the sealing lips 60 against the indicated end surfaces of the auxiliary rings 50 so that the space to be sealed is reliably protected against penetration of moisture and/or dirt particles even under this loading.

The gasket 60 is furthermore made in several parts. Thus, for example in the illustrated embodiment it comprises a perforated disk-like support body 64 which forms the back of the C-shape and to which an outer and an inner elastomer part 66 and 68 are vulcanized. In this connection the outer elastomer part 66 together with the support body 64 is designed for attachment to the corresponding shape of the outer sleeve 20. The inner elastomer part 68 is made to form a V-shaped sealing lip 62 and furthermore has an extension 63 which runs in the peripheral direction, which protrudes radially to the inside, which like the tip of the V-shape of the sealing lip 62 is properly spaced to the opposite jacket surface of the auxiliary ring 50, and which for the space which is to be sealed and which is filled at least partially with lubricating grease performs a grease retention and return function. In another embodiment the gasket can also be formed entirely from PTFE.

FIG. 3 shows as another embodiment of the invention a gasket 60′ which, in contrast to the gasket 60 of FIGS. 1 and 2, is additionally provided with an annular spring 70 which is inserted into the groove formed by the V-shape of the sealing lip 62′. Thus, relative to the gasket 60 of FIGS. 1 and 2 for an additional sealing action the tip of the V-shape of the gasket 60′ is caused to adjoin the correspondingly opposite jacket surface of the auxiliary ring 50. Otherwise what was described above regarding FIGS. 1 and 2 applies accordingly.

The sealing arrangements described above within the framework of the bicycle pedal crank bearing can of course also be used elsewhere on a bicycle, for example in the wheel hubs.

### REFERENCE NUMBER LIST

10 shaft
20 outer sleeve
25 intermediate sleeve
32 cylinder roller
42 ball
34, 44 cage
50 auxiliary ring
60, 60′ gasket
62, 62′ sealing lip
63 extension
64 support body
66, 68 elastomer part
70 annular spring

1. Seal arrangement of a bicycle with the following features comprising:
a first element (10) which extends in the an axial direction;
a second element (20) which extends in the axial direction and which surrounds the first element at least in a partial region;
the first and second elements (10, 20) are being pivotally supported against one another;
a space which is to be sealed and which extends extending between the first and second elements, (10, 20) is the space being closed in the a region of at least one axial end section of one of the first and second elements (10, 20) with a gasket (60, 60′) which is located essentially between the first and second elements; (10, 20) and
the gasket (60, 60′) is being attached to the second element (20) and has comprising a sealing lip (62, 62′) which adjoins the a surface of the first element (10), forming a seal, which surface runs extends peripherally in the an annular manner of a ring and extends in the a radial direction.

2. Seal arrangement as claimed in claim 1, wherein the first element (10) comprises a ring-like element (50) which forms the indicated surface and which is connected to the first element (10).

3. Seal arrangement as claimed in claim 2, wherein the ring-like element (50) possesses a lengthwise sectional profile that is made roughly with a generally L-shaped lengthwise sectional profile.

4. Seal arrangement as claimed in claim 3, wherein the ring-like element (50) is arranged such that the a corner point of the L-shape adjoins the first element (10) as an axially outer point of the ring-like element (50) with respect to the space which is to be sealed.

5. Seal arrangement as claimed in one of claims 2 to 4 claim 2, wherein a narrow hollow-cylindrical gap exists in a radial direction between an outer peripheral surface of the ring-like element (50) with its outside jacket surface in the radial direction to the opposite inner jacket and a facing inner peripheral surface of the second element (20) is made and arranged to form a narrow hollow-cylindrical gap.

6. Seal arrangement as claimed in one of claims 2 to 5 claim 2, wherein the gasket (60, 60′) is located essentially between the ring-like element and the second element (50, 20).

7. Seal arrangement as claimed in one of claims 1 to 6 claim 1, wherein the sealing lip (62, 62′) is made protruding to the protrudes axially in a direction toward outside in the axial direction the seal arrangement.

8. Seal arrangement as claimed in one of claims 1 to 7 claim 1, wherein the gasket (60, 60′) possesses a lengthwise sectional profile that is generally made roughly with a C-shaped lengthwise sectional profile.

9. Seal arrangement as claimed in claim 8, wherein the gasket (60, 60′) is arranged such that the a back of the generally C-shaped gasket extends essentially generally in the a radial direction and is located in the an axial direction toward the an inside with respect to of the space to be sealed.

10. Seal arrangement as claimed in one of claims 8 or 9 claim 8, wherein the generally C-shaped gasket comprises a generally axially extending radially inner part possessing an end portion roughly axially running inner part of the C-shape on the end opposite the sealing lip, the end portion forming shoulder comprises an extension (63) which protrudes essentially to the inside in the radial direction generally radially inwardly.

11. Seal arrangement as claimed in one of claims 1 to 10 claim 1, wherein the sealing lip (62, 62′) is made roughly with a possesses a lengthwise sectional profile that is generally V-shaped lengthwise sectional profile.

12. Seal arrangement as claimed in claim 11, wherein the generally V-shaped sealing lip on the radially inner end of the C-shape is made configured to continue the C-shape of the gasket.

13. Seal arrangement as claimed in one of claims 11 or 12 claim 11, wherein the sealing lip (62, 62′) is arranged such that the a tip of the V-shaped sealing lip in the radial direction is nearest the first element (10).

14. Seal arrangement as claimed in one of claims 1 to 13 claim 1, wherein the gasket (60, 60′) comprises an annular spring (70).

15. Seal arrangement as claimed in claim 14, wherein the annular spring (70) is located in the opening of the V-shape of the a groove formed by two legs of the V-shaped sealing lip (62, 62′).

16. Seal arrangement as claimed in one of claims 1 to 15 claim 1, wherein the gasket (60, 60′) comprises a support body (64) and at least one elastomer part (66, 68).

17. Seal arrangement as claimed in one of claims 1 to 15 claim 1, wherein the gasket (60, 60′) is made completely from PTFE.

18. Seal arrangement as claimed in one of claims 1 to 17 claim 1, wherein the first and the second element (10, 20) can be turned elements are turnable against one another via at least one antifriction bearing which is located within the space to be sealed.

19. Seal arrangement as claimed in claim 18, wherein the first and second elements (10, 20) are made to form the antifriction bearing tracks of the antifriction bearing.

20. Bicycle pedal crank bearing with a seal arrangement as claimed in one of claim 1.

21. Bicycle hub with a seal arrangement as claimed in one of claim 1.

22. Bicycle pedal crank bearing comprising:
a shaft possessing an outer peripheral surface;
an outer sleeve surrounding the shaft and possessing an inner peripheral surface;
one end of the shaft extending axially outwardly beyond one end of the outer sleeve;
the shaft and the outer sleeve being radially spaced from one another so that a space exists between the outer peripheral surface of the shaft and the inner peripheral surface of the outer sleeve;
a bearing positioned between the outer sleeve and the shaft;
an annular member at the one end of the shaft;
the annular member possessing an annular radially extending surface facing axially inwardly toward the space;
a gasket positioned relative to the shaft and the outer sleeve to close the space at one axial end section of the shaft and the outer sleeve;
the gasket being attached to the outer sleeve adjacent the one end of the outer sleeve;
the gasket comprising a sealing lip adjoining the surface of the annular member and forming a seal.
